(19) United States
(12) Patent Application Publication
(10) Pub. No.: US 2008/0233535 A1
(43) Pub. Date: Sep. 25, 2008

(54) Dental implement and method for inhibiting bleeding during a root canal procedure

(76) Inventor: Charles Lee, Lenexa, KS (US)

Correspondence Address: HARSHAW RESEARCH, INC., 210 W. TECUMSEH STREET, OTTAWA, KS, 66067, US

(21) Appl. No.: 11/726,120

(22) Filed: Mar. 21, 2007

(51) Int. Cl. A61C 5/02

(52) U.S. Cl. 433/81

(57) ABSTRACT

A dental implement for applying a hemostatic compound to a root canal of a person's tooth includes an elongate applicator having an upper section and a lower section. The lower section includes a tip having a generally pointed configuration. The tip and lower section may be coated with a hemostatic agent that inhibits bleeding. A user may hold the applicator by its upper section and insert the lower section and tip into a root canal for applying the hemostatic compound to the tissues therein, whereby to inhibit bleeding during a root canal procedure.

### BACKGROUND OF THE INVENTION

This invention relates generally to a dental implement and, more particularly, to a dental implement that applies a hemostatic compound to a root canal during a root canal procedure to inhibit bleeding therein.

A deep cavity or fracture of a tooth or even a cavity that forms under a previous filling may lead to bacteria that may seep beneath the enamel and dentin and into the pulp chamber of the tooth. This bacteria may then cause an infection of the pulp and nerves inside the tooth. The tooth may become abscessed, causing severe tooth pain especially when biting or chewing. This dental condition may be remedied through an oral surgical procedure known as a root canal therapy. In a traditional root canal, the decay may be removed with a drill so as to open a channel to the pulp chamber. All of the pulp is removed and special files are used to clean and enlarge the root canals themselves. The root canals are then filled with cones made of rubber material called gutta percha. Additional gutta percha or filling material is inserted to fill the rest of the pulp chamber. A porcelain or gold crown may be used to seal the crown of the tooth.

As would be expected in any surgical procedure, living tissue includes blood vessels that bleed when cut and this blood flow must be stopped during the procedure so that the dentist can see clearly to perform the procedure and to prevent the blood from interfering with the operation. More particularly, a dentist frequently inserts a “paperpoint” into the root canal to collect and absorb blood. Further, the dentist or dental technician may apply a hemostatic compound to the paperpoint or similar implement prior to its insertion so that the meostatic compound is applied directly to the root canal for inhibiting or completely stopping bleeding.

Having to first deposit a quantity of a hemostatic compound onto the implement or first onto an intermediate cloth or mat before recovering a portion onto the implement prior to inserting the implement into a respective root canal is very inconvenient and inefficient. Therefore, it would be desirable to have a dental implement, such as a paperpoint implement, that includes a hemostatic compound for immediate application to a bleeding oral cavity.

### SUMMARY OF THE INVENTION

A dental implement according to the present invention includes an applicator having an upper section and a lower section. The lower section includes a tip having a generally pointed configuration. The lower section and tip are either coated or impregnated with a hemostatic compound that inhibits bleeding. The tip and lower section of the implement may be inserted into tooth root canal that is bleeding such that the hemostatic compound contacts the tissue that is bleeding. The implement may then be withdrawn such that the doctor or technician may observe whether the bleeding has stopped. If not, the implement may be inserted again or another treated implement may be inserted so as to apply more of the hemostatic compound to the bleeding area of the root canal area.

Therefore, a general object of this invention is to provide a dental implement and method for inhibiting bleeding in a root canal.

Another object of this invention is to provide an implement, as aforesaid, that includes an elongate applicator having a generally pointed tip that may be easily manipulated and inserted into a root canal.

Still another object of this invention is to provide a dental implement, as aforesaid, in which a portion of the applicator is coated with a hemostatic compound that inhibits bleeding when applied to bleeding tissue.

A further object of this invention is to provide a dental implement, as aforesaid, in which the applicator is a paperpoint.

Yet another object of this invention is to provide a method of inhibiting bleeding in a root canal that includes the steps of inserting the coated portion of the applicator into a root canal, withdrawing the applicator, and observing whether bleeding has ceased.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an implement according to a preferred embodiment of the present invention;

FIG. 2 is another perspective view of the implement as in FIG. 1 in a partially unrolled configuration;

FIG. 3 is front view of the implement as in FIG. 1 in a fully unrolled configuration; and

FIG. 4 is a fragmentary view of a tooth with the implement partially inserted into a root canal.

### DESCRIPTION OF THE PREFERRED EMBODIMENT

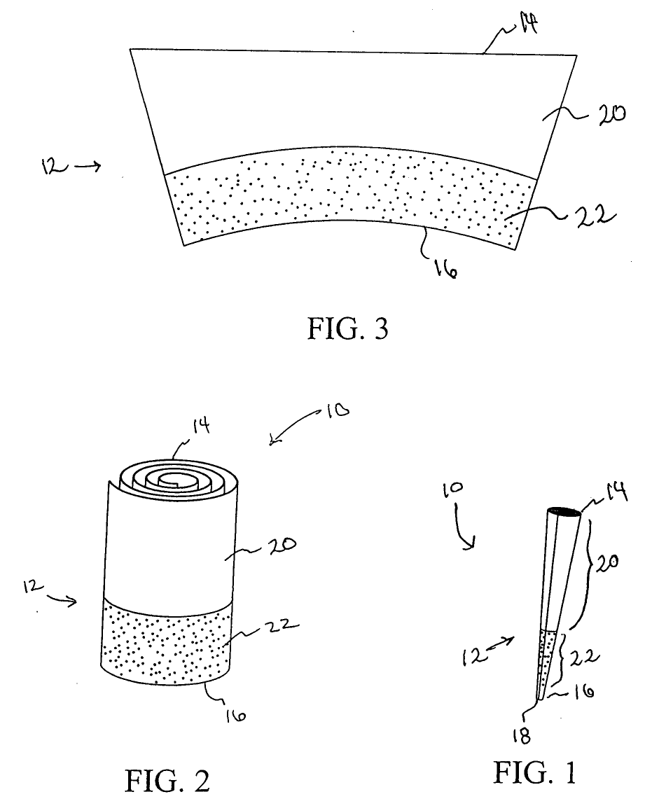

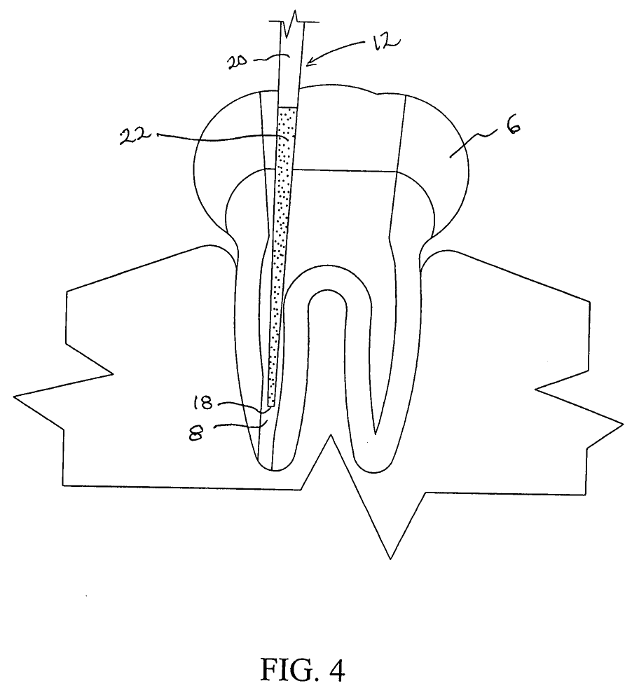

A dental implement and method for inhibiting bleeding in a root canal will now be described in detail with reference to FIGS. 1 to 4. The dental implement 10 includes an applicator 12 having opposed first 14 and second 16 ends (FIG. 1). The second end 16 includes a tip 18 having a generally pointed configuration. Preferably, the applicator 12 is constructed of a tightly wound paper material and having a generally cylindrical configuration, such as a so-called “paperpoint.”

The applicator 12 includes an upper section 20 adjacent to and extending downwardly from the first end 14 and a lower section 22 adjacent to and extending upwardly from the second end 16. The lower section 22 may have a length smaller than a length of the upper section such that the upper section 20 may extend from the first end 14 beyond the midway point between the first 14 and second 16 ends. The upper section 20 presents a diameter larger than a diameter of the lower section 22. This size difference enables a person to easily grasp the upper section and manipulate the position and orientation of the applicator 12 and allows the lower section to be inserted into a root canal of a tooth.

The lower section 22 is also diametrically smaller so that it may be inserted appropriately into a person's mouth and to contact bleeding tissue, such as in a root canal, for example. More particularly, a root canal 8 may present a generally tapered configuration after being hollowed out during a root canal therapy and the generally tapered configuration of the application 12 fits neatly therein.

The lower section 22 of the applicator 12 includes a hemostatic compound that is formulated to inhibit or completely stop bleeding within the root canal 8 of a tooth 6 (FIGS. 1-4). The hemostatic compound is preferably ferric sulfate although other compounds that inhibit bleeding would also be suitable. The hemostatic compound may be coated on an exterior surface of the tip 18 and lower section 22 of the applicator 12. This coating would ideally be applied to the applicator 12 at the point of manufacture and a plurality of prepared applicators 12 would be packaged together for use by medical professionals such as dentists during oral surgical procedures like root canals. Alternatively, the lower section 22 may be impregnated with the hemostatic compound. In other words, the paper material of the implement 10 may be specially treated to include the hemostatic compound.

In use, the implement 10 may be used to inhibit bleeding during a root canal dental procedure. Specifically, when a root canal 8 has been exposed and the pulp is being removed therefrom, bleeding will occur. An implement 10 according to the present invention may be inserted into the root canal 8 in order to inhibit or even completely stop that bleeding. Bleeding is stopped because the lower section 22 and tip 18 of the applicator 12 includes a hemostatic agent such as ferric sulfate. The implement 10 may be repeatedly inserted and removed and then re-inserted (or a new implement inserted) until the bleeding has been stopped. The present invention presents a new efficiency to the root canal procedure in that the hemostatic agent is already present on the applicator 12 without requiring any proactive step of the dentist or technician to apply the agent to the applicator 12.

It is understood that while certain forms of this invention have been illustrated and described, it is not limited thereto except insofar as such limitations are included in the following claims and allowable functional equivalents thereof.

What is claimed is as follows:

1. A dental implement for applying a hemostatic compound to bleeding tissues in a root canal system, comprising:
an elongate applicator having a first end and a second end opposite said first end, said second end having a generally pointed configuration; and
a hemostatic compound on said applicator adjacent said second end for contacting the bleeding tissues of the root canal system in order to inhibit bleeding therein.

2. The dental implement as in claim 1 wherein said applicator includes a tightly wound paper construction having a generally cylindrical configuration.

3. The dental implement as in claim 1 wherein said applicator includes an upper section adjacent said first end and a lower section adjacent said second end, said lower section being coated with said hemostatic compound.

4. The dental implement as in claim 1 wherein said applicator includes an upper section adjacent said first end and a lower section adjacent said second end, said lower section being impregnated with said hemostatic compound.

5. The dental implement as in claim 4 wherein said upper section has a diameter that is larger than a diameter of said lower section, said upper section having a size for manipulation by fingers of a user.

6. The dental implement as in claim 1 wherein said hemostatic compound is selected from the group consisting of ferric sulfate and aluminum chloride.

7. A method for inhibiting bleeding in a root canal of a person's tooth during a root canal procedure, comprising:
providing an applicator having a tip containing a hemostatic substance for inhibing bleeding;
inserting said implement into the root canal such that said tip contacts a point therein that is bleeding;
withdrawing said implement and observing if the bleeding has ceased; and
repeating said steps of inserting, withdrawing, and observing until the bleeding has ceased.

8. The method as in 7 wherein said applicator includes a tightly wound paper construction.

9. The method as in claim 7 wherein said applicator includes an upper section adjacent said first end and a lower section adjacent said second end, said lower section being coated with said hemostatic compound.

10. The method as in claim 9 wherein said upper section includes a diameter that is larger than a diameter of said lower section so that said upper section may be manipulated by a person's fingers in order to change the position of said tip.

11. The method as in claim 8 further comprising manipulating said upper section of said implement when said tip is position in said root canal such that said hemostatic compound is thoroughly applied to tissue that is bleeding.

12. A dental implement for applying a hemostatic compound to a root canal of a person's tooth, said implement comprising:
an elongate applicator having an upper section and a lower section, said lower section including a tip having a generally pointed configuration; and
a hemostatic compound positioned in proximity to said tip for inhibiting bleeding.

13. The dental implement as in claim 12 wherein said applicator includes a tightly wound paper construction.

14. The dental implement as in claim 12 wherein said lower section is impregnated with said hemostatic compound.

15. The dental implement as in claim 12 wherein said lower section is coated with said hemostatic compound.

16. The dental implement as in claim 12 wherein said hemostatic compound is ferric sulfate.
